(19) United States
(12) Patent Application Publication
(10) Pub. No.: US 2014/0204318 A1
(43) Pub. Date: Jul. 24, 2014

(54) LCD DEVICE AND METHOD FOR ARRANGING POLARIZERS OF THE LCD DEVICE

(71) Applicant: SHENZHEN CHINA STAR OPTOELECTRONICS TECHNOLOGY CO., LTD., Shenzhen (CN)

(72) Inventors: Chihtsung Kang, Shenzhen (CN); Bo Hai, Shenzhen (CN)

(73) Assignee: SHENZHEN CHINA STAR OPTOELECTRONICS TECHNOLOGY CO., LTD., Shenzhen (CN)

(21) Appl. No.: 13/824,331

(22) PCT Filed: Feb. 26, 2013
(86) PCT No.: PCT/CN2013/071903

§ 371 Date: Mar. 15, 2013

(30) Foreign Application Priority Data
Jan. 21, 2013 (CN) 201310021316.4

(51) Int. Cl. G02F 1/1335

(52) U.S. Cl. CPC G02F 1/133528
USPC 349/102; 349/96

(57) ABSTRACT

A liquid crystal display (LCD) device includes an LCD panel, a first polarizer arranged on a first side of the LCD panel, a second polarizer arranged on a second side of the LCD panel, and a λ/2 wave plate arranged between the first polarizer and the second polarizer.

### TECHNICAL FIELD

The present disclosure relates to the field of liquid crystal display (LCD), and more particularly to an LCD device, and a method for arranging polarizers of the LCD device.

### BACKGROUND

In a liquid crystal display (LCD) device, an LCD panel may not normally display an image without polarization of a polarizer. The polarizer absorbs light that is perpendicular to a polarization axes, only permits the light in a direction of the polarization axes to pass, and converts natural light into linearly polarized light. Because the polarizer is made of a material that is in a film or plate form, the polarizer is also called a polarizing film or a polarizing plate.

Vertical alignment (VA) display mode refers to the relative VA display mode of liquid crystal (LC) molecules and substrates. Since the VA display mode has various characteristics such as having a wide viewing angle, high contrast, and no need of a friction alignment, the VA display mode is a common display mode for a thin film transistor LCD (TFT-LCD) for a large-size television TV.

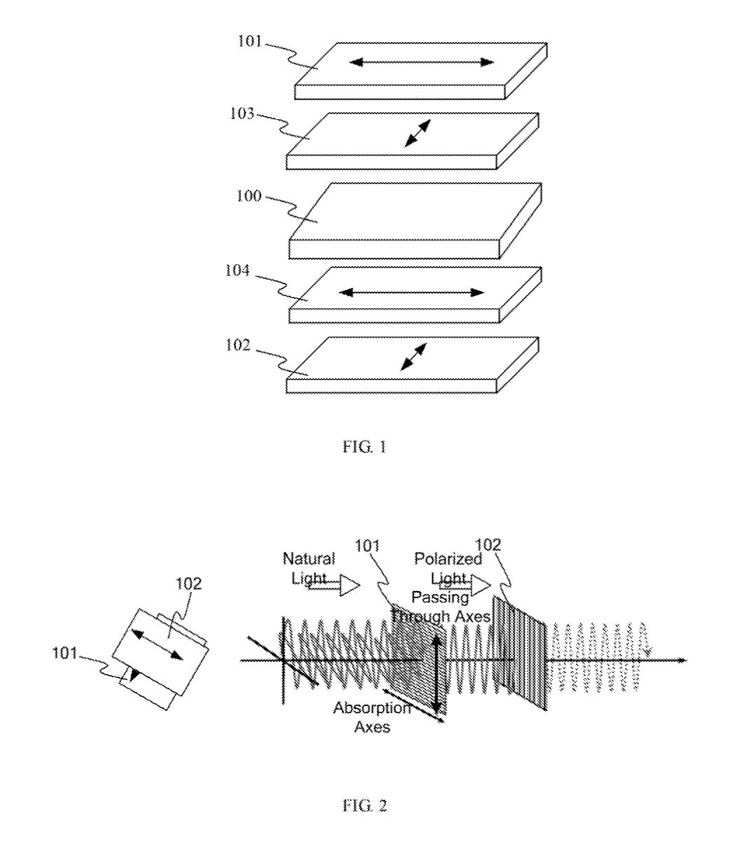

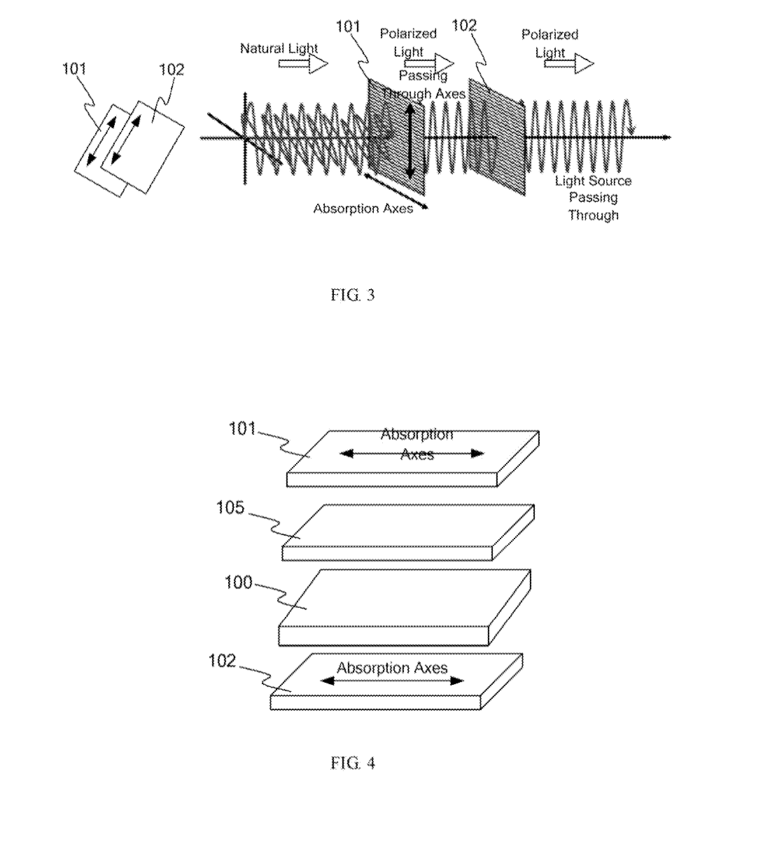

FIG. 1 shows a polarizer structure of the LCD panel. A first polarizer 101 and a second polarizer 102 are arranged on two sides of the LCD panel 100 of the VA display mode, respectively. A first compensation film 103 is arranged between the first polarizer 101 and the LCD panel 100, and a second compensation film 104 is arranged between the second polarizer 102 and the LCD panel 100. When a voltage is not applied, an incident light may not deflect when the incident light passes through the LCD panel 100 of the VA display mode. As shown in FIG. 2, because the first polarizer and the second polarizer are vertically laminated (absorption axes are perpendicular to each other), when voltage is not applied, the natural light forms a polarized light when the natural light passes through the first polarizer 101, and then the polarized light is absorbed by the second polarizer 102. At this moment, the LCD device is in a normal black mode. If the first polarizer and the second polarizer are laminated in parallel (the absorption axes are in parallel with each other), as shown in FIG. 3, the natural light forms the polarized light when the natural light passes through the first polarizer 101, but is still able to pass through the second polarizer 102. At this moment, the LCD device is in a normal white mode.

Generally speaking, the LCD device in the VA display mode is in the normal black mode when the voltage is not applied, namely the first polarizer and the second polarizer are vertically laminated. Thus, in a dark state, a display brightness of the LCD device is very low, which makes high contrast. Moreover, the dark state occurs when pixels are damaged, which appears as a dark spot on the LCD panel, and slightly affects an image display, otherwise appears as a bright spot on the LCD panel, and greatly affects the image display.

However, in manufacturing the large-size LCD devices, the vertical lamination of the first polarizer and the second polarizer may be limited by material. At present, the polarizers manufactured by a polarizer manufacturing equipment are in a coil form, and are cut into an appropriate size in accordance with a size of LCD panels as required. A width of the polarizers in the coil form, at present, is limited, for example, if a length of the LCD panel is L and a width of the LCD panel is W, and a maximum width of the polarizers in the coil form is W, the first polarizer with the length of L and the width of W is obtained by cutting off the polarizers in the coil form. However, because the absorption axes of the second polarizer and the absorption axes of the first polarizer are arranged perpendicular to each other, an appropriate size of second polarizer may not be obtained. Therefore, when the length L of the LCD panel exceeds the width of the polarizers in the coil form, one of the two polarizers, which are vertically laminated, may not cover the total LCD panel because the width of the polarizers may not meet the requirement that the polarizers in the coil form may not be cut into two polarizers which have the same size and have the absorption axes which are perpendicular to each other. Optionally, a mode of splicing polarizers can be used to achieve the vertical lamination of the first polarizer and the second polarizer. However, a bright line may be produced at a spliced position, which is an unacceptable situation in a process of manufacturing LCD panels. Thus, the large-size LCD panels exceeding the width of the polarizers may not normally achieve a normal black mode in accordance with existing structures. Therefore, the problem needs to be solved urgently

### SUMMARY

In view of the above-described problems, an aim of the present disclosure is to provide a large-size LCD panel of a liquid crystal display (LCD) device can normally achieve a normal black mode.

The aim of the present discourse is achieved by the following technical scheme.

An LCD device comprises an LCD panel, a first polarizer arranged on a first side of the LCD panel, a second polarizer arranged on a second side of the LCD panel, and a λ/2 wave plate arranged between the first polarizer and the second polarizer.

An absorption axes of the first polarizer is in parallel with an absorption axes of the second polarizer.

In one example, a compensation value of an entire waveband of the λ/2 wave, plate is ½ of a corresponding wavelength of light, which increases a contrast of the LCD panel of the LCD device.

In one example, the λ/2 wave plate is arranged between the first polarizer and the LCD panel.

In one example, the λ/2 wave plate is arranged between the second polarizer and the LCD panel

In one example, an included angle between a slow axes of the λ/2 wave plate and the absorption axes of the first polarizer is 45°, and the included angle between the slow axes of the λ/2 wave plate and the absorption axes of the second polarizer is 45°, which increases the contrast of the LCD panel.

In one example, the included angle between the slow axes of the λ/2 wave plate and the absorption axes of the first polarizer is 135° and the included angle between the slow axes of the λ/2 wave plate and the absorption axes of the second polarizer is 135°.

A method for arranging polarizers of the LCD device comprises:

A: arranging a λ/2 wave plate on a first side of the LCD panel;

B: arranging a first polarizer and a second polarizer on two sides of the LCD panel to make an absorption axes of the first polarizer is in parallel with an absorption axes of the second polarizer.

In one example, a compensation value of an entire waveband of the λ/2 wave plate is ½ of a corresponding wavelength of light.

In the present disclosure, because the absorption axes of the first polarizer and the second polarizer are arranged in parallel, a width of the polarizers is sufficiently applied to the large-size LCD panel, and light passing through the first polarizer and the λ/2 wave plate is absorbed by the second polarizer, the λ/2 wave plate is arranged between the first polarizer and the second polarizer, the LCD device is able to display the normal black mode.

### BRIEF DESCRIPTION OF FIGS.

FIG. 1 is a simple structural diagram of a liquid crystal display (LCD) panel and polarizers of an LCD device in a prior art.

FIG. 2 is a structural and schematic diagram of the polarizers of the LCD device in a normal black mode in the prior art.

FIG. 3 is a structural and schematic diagram of the polarizers of the LCD device in the normal white mode in the prior art.

FIG. 4 is a simple structural diagram of the LCD panel, the polarizers and a wave plate of the LCD device of an example of the present disclosure.

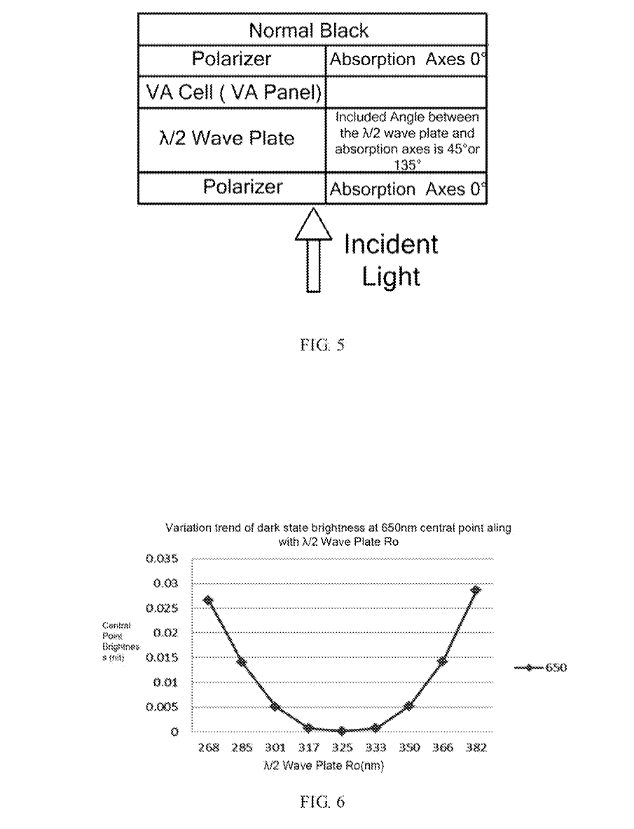

FIG. 5 is a simple angle diagram of the LCD panel, the polarizers and the wave plate of the LCD device of the example of the present disclosure.

FIG. 6 is a variation diagram of compensation values of different λ/2 wave plates corresponding to light with wavelength of 650 nm.

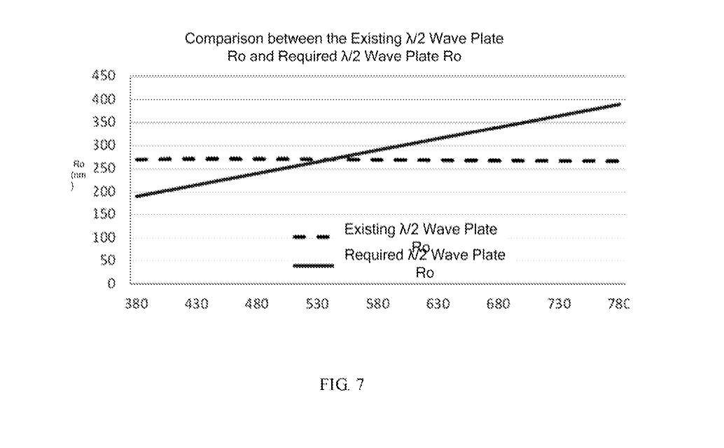

FIG. 7 is a schematic diagram of existing λ/2 wave plate and required wave plate corresponding to the compensation values of light of different wavebands.

Legends: 100. LCD panel, 101. first polarizer, 102. second polarizer, 103. first compensation film, 104. second compensation film, 105. λ/2 wave plate.

### DETAILED DESCRIPTION

The present disclosure provides a large-size liquid crystal display (LCD) device that is made of an existing polarizer material and is able to normally display a normal black mode. In the present disclosure, because an absorption axes of a first polarizer and a second polarizer of the LCD device are arranged in parallel, a width of the polarizers is sufficiently applied to a large-size LCD panel, and light passing through the first polarizer and a λ/2 wave plate is absorbed by the second polarizer, the λ/2 wave plate is arranged between the first polarizer and the second polarizer, the LCD device is able to display the normal black mode. Optionally, the present disclosure is also applicable to normal-sized LCD devices. For the normal-sized LCD devices, only the polarizers arranged in parallel are manufactured for a standard size without additionally manufacturing one of the polarizers having absorption axes that are in parallel with each other.

The present disclosure is further described in detail in accordance with the figures and the examples.

As shown in FIG. 4 and FIG. 5, the LCD device comprises an LCD panel 100, a first polarizer 101 and a second polarizer 102 that are arranged on two sides of the LCD panel 100, and a λ/2 wave plate 105 (λ is a wavelength of light) arranged between the first polarizer 101 and the LCD panel 100. An absorption axes of the first polarizer 101 is in parallel with an absorption axes of the second polarizer 102. When an included angle between a slow axes or a fast axes of the λ/2 wave plate 105 and the absorption axes of the first polarizer 101 is 45°, and the included angle between the slow axes or the fast axes of the λ/2 wave plate 105 of the absorption axes of the second polarizer 102 is 45°, a display contrast of the LCD is a maximum. Accordingly, when the included angle between the slow axes or fast axes of the λ/2 wave plate 105 and the absorption axes of the first polarizer 101 is 135°, and the included angle between the slow axes or the fast axes of the λ/2 wave plate 105 and the absorption axes of the second polarizer 102 is 135°, the display contrast of the LCD is also the maximum.

In the example, the λ/2 wave plate 105 may be arranged between the second polarizer 102 and the LCD panel 100 as well because the λ/2 wave plate 105 is used to enable the polarized light passing through the first polarizer 102 to produce λ/2 phase delay.

The present disclosure will further be described in details by simulating an existing polarizer structure of the LCD device and a polarizer structure of the example.

A simulation is performed in the example by using the LCD Master simulation software.

Simulation setting is as follows:

LC setting:

1: Set a pretilt angle: 89°;

2: Define 4domain LC azimuth: 45°, 135°, 225°, and 315°.

Light source setting:

1: Simulate to use Blue-YAG LED spectrum

2: Define central brightness: 100 nit

3: Light source distribution is Lambert's distribution

For the condition of setting same experimental parameters, the existing polarizer structure and the polarizer structure of the example are simulated, and the results are as follows:

A dark state brightness, a bright state brightness, and a contrast of the existing polarizer (POL) structure in normal black mode are as follows:

| 0 V Level | 7 V Level | CONTRAST |
|---|---|---|
| 0.019966 | 34.348 | 1720 |

If the POL structure of the example, namely the structure shown in FIG. 5 is used, the simulated results are as follows when the included angles between the slow axes of the λ/2 wave plate and the absorption axes of the POL are different:

| λ/2 ANGLE | 0 V Level | 7 V Level | CONTRAST |
|---|---|---|---|
| Included angles | 0.4885 | 34.3 | 70 |
| between the slow axes of the | | | |
| λ/2 wave plate and the | | | |
| absorption axes of the POL | | | |
| is 45° or 135° | | | |
| the slow axes of the λ/2 | 35.43 | 0.915 | 39 |
| wave plate is parallel or | | | |
| perpendicular to the | | | |
| absorption axes of the POL | | | |

It can be seen that when the slow axes of the wave plate is parallel or perpendicular to the absorption axes of the POL, the LCD device is in a bright state and a normal white mode at 0V, and the LCD device is in a normal black mode at 7V, When the included angle between the slow axes of the λ/2 wave plate and the absorption axes of the POL is 45° or 135°, the LCD device is in the normal black mode. However, the brightness is slightly high at 0V which makes con frost of the LCD panel be low.

This is because of the slight variation of the wave plate used in the simulation corresponding to compensation values (Ro) of different wavelengths of the light. The parameters of the existing λ/2 wave plate are as follows

| | λ/2 Wave Plate RGB RO | | |
|---|---|---|---|
| WAVELENGHTH | Nₓ | N_{y} | RO |
| 450 | 1.54921 | 1.54098 | 271 |
| 550 | 1.54089 | 1.53270 | 270 |
| 650 | 1.53610 | 1.52797 | 268 |

Thus, we simulate a requirement of the required λ/2 wave plate.

The relationship between compensation values Ro, Rth and refractive index N, and thickness d is as follows:

Ro=(Nx−Ny)*d

Rth=[(Nx+Ny)/2−Nz]*d

Take 650 nm as an example, we design different λ/2 Re corresponding to the 650 nm. FIG. 6 shows the simulated results. When the compensation value of the λ/2 wave plate is 325 nm, a brightness of the central point in the dark state is a minimum, it can be seen that when the compensation value of the λ/2 wave plate is ½ of 650 nm, the brightness of the light is the minimum, similarly, for the light with different wavelengths of the light, if the compensation value is λ/2 of the wavelength of the light, the brightness of the light is also the minimum.

Therefore, the λ/2 wave plate has the characteristics shown in FIG. 7 that the compensation value (Ro) of the light of an entire waveband corresponding to the λ/2 wave plate is increased with an increase of the wavelength of the light, and the compensation value is ½ of the wavelength of the light of each waveband.

As shown in the Table below, When all the compensation values of the λ/2 wave plate corresponding to the wavelength of the light of each waveband are ½ of the wavelength of the light of the waveband, the simulated results of the LCD device of the example are as follows:

| | 0 V Level | 7 V Level | CONTRAST |
|---|---|---|---|
| Parameters | 0.02013 | 34.618 | 1720 |
| of novel | | | |
| λ/2 wave | | | |
| plate | | | |

It can be seen that using, the parameters of the novel λ/2 wave plate to perform simulation may really and effectively reduce the brightness in the dark state, and may effectively increase the contrast without sacrificing the brightness in the bright state. The novel λ/2 wave plate may be obtained by the formula . In accordance with the formula, the novel λ/2 wave plate may achieve the parameters by simultaneously changing the refractive index Nx, Ny, and thickness d of the novel λ/2 wave plate. In a process of manufacturing the wave plate, the refractive index Nx, Ny, and the thickness d of the wave plate are adjusted to enable the parameters of the wave plate to be coincident with or approximate to the parameters shown in FIG. 7.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A liquid crystal display (LCD) device, comprising:
an LCD panel;
a first polarizer arranged on a first side of the LCD panel;
a second polarizer arranged on a second side of the LCD panel; and
a λ/2 wave plate arranged between the first polarizer and the second polarizer, wherein an absorption axes of the first polarizer is in parallel with an absorption axes of the second polarizer; a compensation value of an entire waveband of the λ/2 wave plate is ½ of a corresponding wavelength of light, the λ/2 wave plate is arranged between the first polarizer and the LCD panel;
an included angle between a slow axes of the λ/2 wave plate and the absorption axes of the first polarizer is 45°; the included angle between the slow axes of the λ/2 wave plate and the absorption axes of the second polarizer is 45°.

2. A liquid crystal display (LCD) device, comprising:
an LCD panel;
a first polarizer arranged on a first side of the LCD panel;
a second polarizer arranged on a second side of the LCD panel; and
a λ/2 wave, plate arranged between the first polarizer and the second polarizer, wherein an absorption axes of the first polarizer is in parallel with an absorption axes of the second polarizer.

3. The LCD device of claim 2, wherein a compensation value of an entire waveband of the λ/2 wave plate is ½ of a corresponding wavelength of light.

4. The LCD device of claim 2, wherein the λ/2 wave plate is arranged between the first polarizer and the LCD panel.

5. LCD device of claim 2, wherein the λ/2 wave plate is arranged between the second polarizer and the LCD panel.

6. The LCD device of claim 2, wherein an included angle between a slow axes of the λ/2 wave plate and the abortion axes of the first polarizer is 45°, and the included angle between the slow axes of the λ/2 wave plate and the absorption axes of the second polarizer is 45°.

7. The LCD device of claim 2, wherein an included angle between a slow axes of the λ/2 wave plate and the absorption axes of the first polarizer is 135°, and the included angle between the slow axes of the λ/2 wave plate and the absorption axes of the second polarizer is 135°.

8. A method for arranging polarizers of a liquid crystal display (LCD) device, comprising;
A: arranging a λ/2 wave plate on a first side of the LCD panel;
B: arranging a first polarizer and a second polarizer on two sides of the LCD panel to make an absorption axes of the first polarizer is in parallel with an absorption axes of the second polarizer.

9. The method for arranging the polarizers of the LCD device of claim 8, wherein a compensation value of an entire waveband of the λ/2 wave plate is ½ of a corresponding wavelength of light.
